(19) United States
(12) Patent Application Publication
(10) Pub. No.: US 2016/0224775 A1
(43) Pub. Date: Aug. 4, 2016

(54) ELECTRONIC APPARATUS HAVING FINGERPRINT SENSOR OPERATING IN VECTOR MODE

(71) Applicant: J-METRICS TECHNOLOGY Co., Ltd., Taipei (TW)

(72) Inventor: Wei-Ting Lin, Taipei (TW)

(21) Appl. No.: 15/003,991

(22) Filed: Jan. 22, 2016

(30) Foreign Application Priority Data
Jan. 29, 2015 (TW) 104103171

(51) Int. Cl. G06F 21/32; G06T 7/60; G06K 9/52; G06K 9/00; G06T 7/20

(52) U.S. Cl. CPC G06F 21/32; G06K 9/00013; G06T 7/20; G06K 9/52; G06T 7/60; G06K 9/00087

(57) ABSTRACT

An electronic apparatus includes a fingerprint sensor and an operation unit. The fingerprint sensor senses fingerprint images of a finger at different time instants. In a vector mode, the operation unit determines one or multiple moving directions of the finger according to the fingerprint images to generate a motion vector signal. The electronic apparatus executes a specific function according to the motion vector signal. The specific function is selected from a group consisting of a homepage key function, a function key function, and an unlocking function.

### CROSS-REFERENCES TO RELATED APPLICATIONS

This non-provisional application claims priority under 35 U.S.C. §119(a) on Patent Application No. 104103171 filed in Taiwan, R.O.C. on 2015 Jan. 29, the entire contents of which are hereby incorporated by reference.

### BACKGROUND

1. Technical Field

The instant disclosure relates to an electronic apparatus, and particularly relates to an electronic apparatus having a fingerprint sensor operating in a vector mode.

2. Related Art

Biometric is a user identification technology based on the uniqueness of fingerprints, facial outlooks, voices, irises, or even DNA molecules of human bodies. To review the developments of identification technologies, password identification was once the commonest one. However, the customer had to bear the risk from forgetting password or personal information leakage. Afterwards, while the developments of smart cards solved the problems for memorizing passwords, the customer still had to worry about the consequences caused by the missing of the smart card once the smart card was missing. Biometric utilizes the physiological features of human bodies as the recognition passwords. Because the expressed physiological features for most people are different from each other, and because the physiological features are parts of the human bodies, the physiological features can be provided as the recognition passwords conveniently. In addition, since the biometric mainly utilizes the physiological features of human bodies as the recognition passwords, the developments of biometric devices head to those devices adapted to recognize biological features which have high recognition accuracies and which are easy to be used.

As compared to a conventional optical recognition device, a capacitive fingerprint recognition chip is small and has the ability for identifying living things. Therefore, the capacitive fingerprint recognition chip would not be cheated by a fake finger easily. In addition, because the application of the capacitive fingerprint chips is no more restricted in governments' recognition systems, the application of fingerprint recognition in consumer electronics grows gradually in the last decade; consumer electronics including flash disks, portable hard drives, laptops, and mobile phones may have fingerprint recognition chips to protect user information. After Apple launched its iPhone 5S installed with fingerprint recognition chip in September of 2013, other mobile phone companies began to launch their devices installed with fingerprint recognition functions. Accordingly, applications of fingerprint recognition in consumer electronics became popular again. In addition, because of the rapid eruption of electrical commerce and mobile payment, fingerprint recognition chips may possibly be the standard equipments of mobile devices.

A conventional fingerprint sensor for mobile device is disposed at the front or the rear of a mobile device. For example, in iOS, the homepage key functions are totally replaced by fingerprint sensors in every generations after Apple's iPhone 5S. Conversely, for mobile devices with Android system, for example, the HTC One Max has the fingerprint sensor at the rear, while Samsung's mobile phone has the fingerprint sensor at the front to replace the homepage key. The fingerprint sensor can provide unlock, encryption, or one-touch function; for example, the fingerprint sensor may be provided as the capturing key when the mobile device is adapted to take a picture.

When the mobile device having fingerprint sensor is adapted to execute the encryption or the unlock function, a user's finger is put on the fingerprint sensor or slides over the fingerprint sensor along a direction, so that the fingerprint sensor can obtain a fingerprint image and compare the fingerprint image with the user fingerprint information stored in the mobile device to determine if the user is a correct user. Such implementation utilizes the unique biometric technology so that the user can be recognized correctly as compared to the conventional password approach; however, it has some risks. For example, when the user is sleeping or in an unconscious situation, an invader may use the finger of the user to execute an encryption function or an unlock function.

FIG. 1 illustrates a schematic view of a conventional electronic apparatus 200. As shown in FIG. 1, the electronic apparatus 200 has a display 230 for displaying information, such as icons 231, screen images, or texts. For the electronic apparatus 200 with Android OS, the return key and the function key are still executed by the touch control function. Commonly, the touch control area 260 of the return key and the touch control area 240 of the function key are respectively located at two sides of the touch control area 250 of the homepage key; however, the positions of the touch control areas may be different for different mobile devices. In addition, in order to allow the electronic apparatus 200 to perform the return key function or the function key function, the touch control sensing wires below the touch control screen of the electronic apparatus 200 have to be extended to the non-display area. Moreover, inks are applied on the protecting sheet of the electronic apparatus 200 to form patterns of the return key and the function keys, and then LEDs 280 and light guiding films 270 are integrated with the protecting sheet. Accordingly, the structure of the conventional electronic apparatus 200 is complicated, and the cost thereof cannot be reduced easily.

### SUMMARY

One object of the instant disclosure is to provide an electronic apparatus having a fingerprint sensor operating in a vector mode. Therefore, the key configuration of the electronic apparatus can be simplified and the fingerprint recognition function can be performed.

To achieve these and other objects, the instant disclosure provides an electronic apparatus. One embodiment of the electronic apparatus includes a fingerprint sensor and an operation unit. The fingerprint sensor senses a plurality of fingerprint images of a finger at different time instants. In a vector mode, the operation unit determines one or multiple moving directions of the finger according to the fingerprint images to generate a motion vector signal. The electronic apparatus executes a specific function according to the motion vector signal. The specific function is selected from a group consisting of a return key function, a function key function, and an unlocking function.

According to the electronic apparatus of embodiments of the instant disclosure, the key configuration of the electronic apparatus can be simplified. In addition, the fingerprint sensor can be adapted to achieve the fingerprint recognition function, the homepage key function, the return key function, and the gesture determination function. Moreover, the security of the electronic apparatus can be improved by the combination of the gesture determination function and the fingerprint recognition function.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims and drawings in the instant disclosure.

### BRIEF DESCRIPTION OF THE DRAWINGS

The disclosure will become more fully understood from the detailed description given herein accompanying by the following figures, which are illustration only, and thus not limitative of the disclosure, wherein:

FIG. 1 illustrates a schematic view of a conventional electronic apparatus;

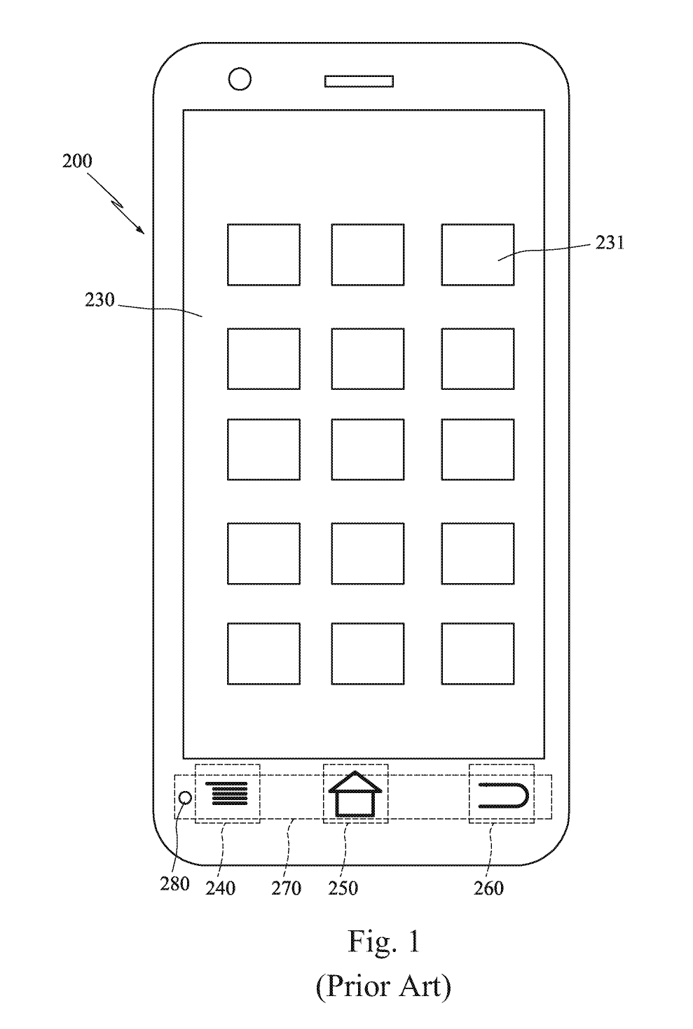

FIG. 2 illustrates a block diagram of a fingerprint sensing recognition module of one embodiment of the instant disclosure;

FIG. 3 illustrates a partial schematic view of an electronic apparatus of one embodiment of the instant disclosure;

FIG. 4 illustrates a block diagram of the electronic apparatus of one embodiment of the instant disclosure;

FIG. 5 illustrates a control procedure flowchart of the electronic apparatus in an unlocked mode of one embodiment of the instant disclosure; and

FIG. 6 illustrates a control procedure flowchart of the electronic apparatus in a locked mode of one embodiment of the instant disclosure.

### DETAILED DESCRIPTION

An embodiment of the instant disclosure provides an electronic apparatus having a fingerprint sensor operating in a vector mode. By the image capturing function of the fingerprint sensor and the determine function of the algorithms of the electronic apparatus, a command representing the return key or the function key is generated accordingly when a user's finger is slid over the fingerprint sensor leftward or rightward. The definitions of the commands may be set by the preference of the apparatus manufacturer. In addition, before or after the fingerprint sensor obtains the fingerprint image of the finger, the user may use his/her finger to write numbers, texts, or to perform a vector command as passwords. Accordingly, the passwords and the fingerprint information are integrated as a safe and secret biometric lock.

An embodiment of the instant disclosure also provides an operating method for the electronic apparatus. The operating method may be installed to the electronic apparatus by firmware or software approaches. The fingerprint sensor may be assembled on a mobile device. The mobile device may be a mobile phone, a tablet, or so. In the following description, the mobile phone is taken as an illustrative example, but embodiments are not limited thereto.

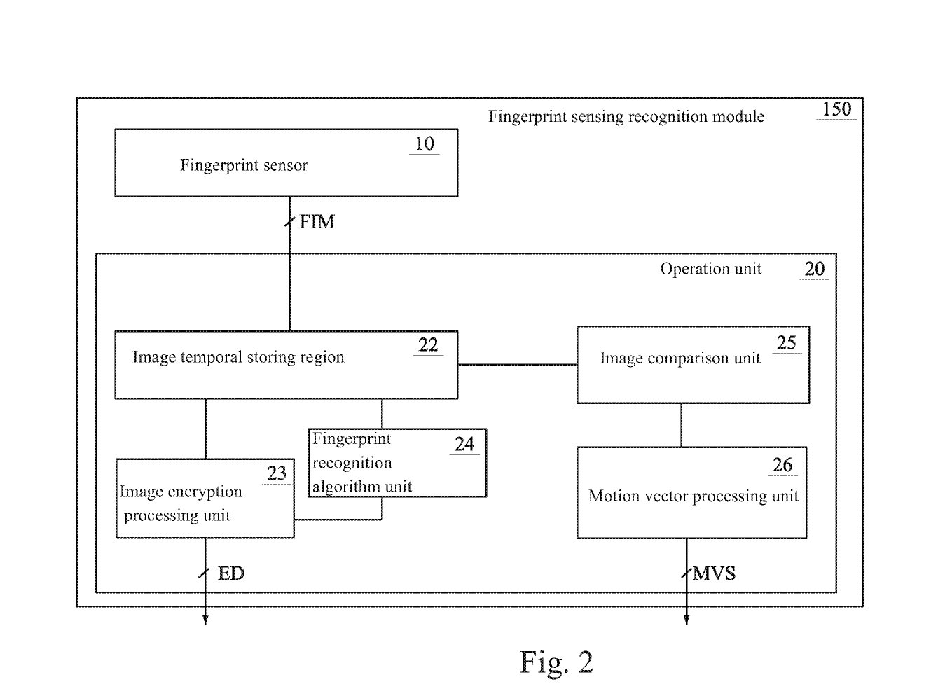

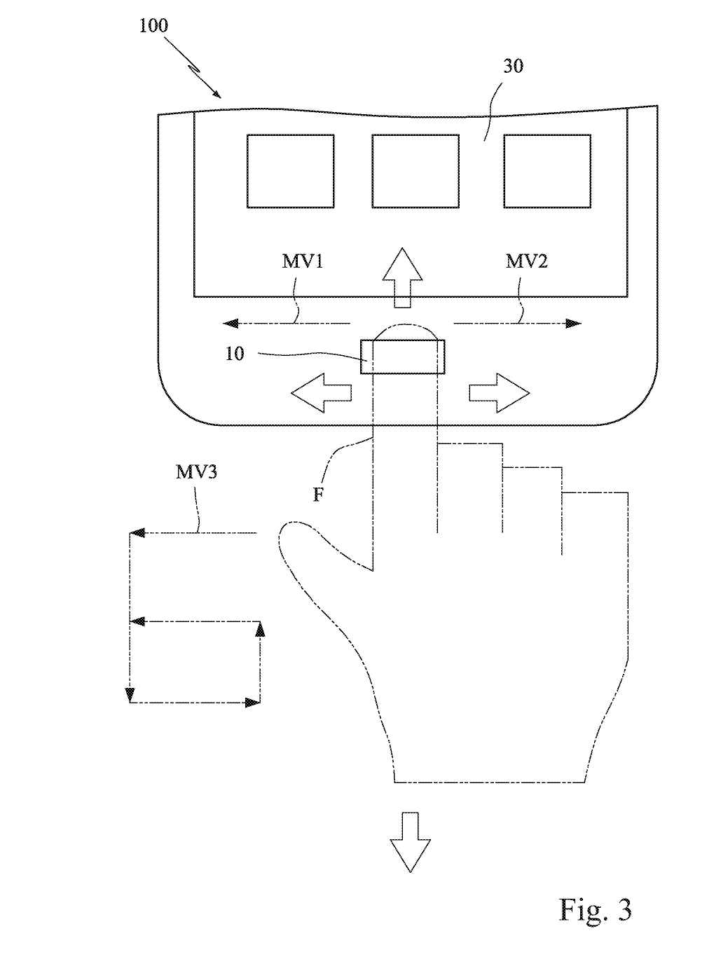

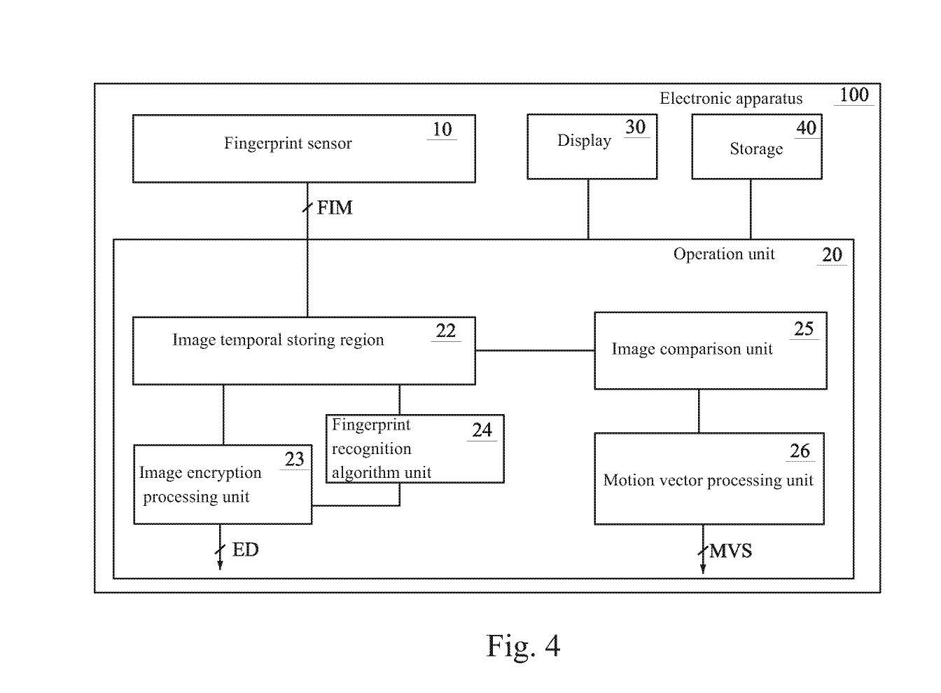

FIG. 2 illustrates a block diagram of a fingerprint sensing recognition module 150 of one embodiment of the instant disclosure. The fingerprint sensing recognition module 150 comprises a fingerprint sensor 10 and an operation unit 20. The operation unit 20 is electrically connected to the fingerprint sensor 10 and outputs encrypted data ED and a motion vector signal MVS. Because the differences between FIG. 2 and FIG. 4 are small, in the following description, FIG. 4 is provided as the illustrative reference for understanding the disclosure. That is, in FIG. 4, the electronic apparatus 100 further comprises a display 30 and a storage 40; while in FIG. 2, the fingerprint sensing recognition module 150 does not comprise a display and a storage. FIG. 3 illustrates a partial schematic view of an electronic apparatus 100 of one embodiment of the instant disclosure. FIG. 4 illustrates a block diagram of the electronic apparatus 100 of one embodiment of the instant disclosure. As shown in FIG. 3 and FIG. 4, the electronic apparatus 100 comprises a fingerprint sensor 10 and an operation unit 20. In addition, the electronic apparatus 100 may further comprise a display 30 and a storage 40.

The fingerprint sensor 10 is provided to sense a plurality of fingerprint images FIM of a finger F at different time instants.

The operation unit 20 may be integrated with the fingerprint sensor 10 in a same chip by hardwarization techniques or may be existed in the electronic apparatus 100 in a format of software or hardware. In a vector mode, the operation unit 20 determines one or multiple moving directions of the finger F according to the fingerprint images FIM to generate the motion vector signal MVS, so that the electronic apparatus 100 executes a specific function according to the motion vector signal MVS. The specific function is selected from a group consisting of a return key function, a function key function, and an unlocking function. The motion vector signal MVS may represent a text, a number, or a vector unit. It is understood that, in the determination of the motion vector, a fingerprint image to be computed by the operation unit may be a whole fingerprint image or a partial fingerprint image. In other words, for a slide-type fingerprint sensor which captures large and elongate shaped images, parts of the fingerprint image or the fingerprint image with fewer pixels would be provided for the comparison. Conversely, for a fingerprint sensor which captures rectangular, round, or polygonal shaped images, a certain region at the middle of the image, for example, an image with pixels of 32*32, may be chosen for the computation to reduce the computation loading or for the concern of energy saving.

The display 30 is electrically connected to the operation unit 20 for displaying information. The information comprises, but not limited to, pictures, texts, or so. The display 30 may have the touch control function.

The storage 40 is electrically connected to the operation unit 20. In a login mode (or called a fingerprint register mode), the operation unit 20 processes one or more of the fingerprint images FIM as fingerprint feature data and stores the fingerprint feature data in the storage 40 for subsequent comparisons.

The operation unit 20 comprises an image temporal storing region 22, an image encryption processing unit 23, a fingerprint recognition algorithm unit 24, an image comparison unit 25, and a motion vector processing unit 26. The fingerprint image FIM output by the fingerprint sensor 10 is stored in the image temporal storing region 22. It is noticed that, the image encryption processing unit 23 may have two parts, one is a processing part, and the other is an encryption part. The processing part processes one or more of the fingerprint images FIM. The image processing procedure may be a fingerprint image recombination procedure for enhancing the sharpness of the fingerprint images FIM. Alternatively, the image processing procedure may be a compression or a simplification procedure of the fingerprint image information for improving the quality or the image transmission speed of the fingerprint images FIM. Therefore, the computation of the subsequent algorithms can be facilitated. On the other hand, the encryption part is provided for executing an encryption procedure. The encrypted fingerprint image is then sent to other units of the operation unit 20, and fingerprint feature points are stored in the storage 40 via algorithm programs. To enter a recognition mode, the fingerprint recognition algorithm unit 24 processes and compares the fingerprint image FIM with the information stored in the storage 40 to obtain a result showing the recognition is passed or failed. To enter the vector mode, the image comparison unit 25 compares the fingerprint images FIM with each other to generate the motion vector signal MVS having one or multiple motion vectors; then, the motion vector processing unit 26 can combine one or multiple motion vectors into a text, a graph, or a simple motion vector MV1, MV2, MV3. The motion vector includes linear displacements with any orientation, displacements having angles, or displacements having pressures.

When the motion vector MV1 is generated, the operation unit 20 obtains the vector command of the motion vector MV1 and sends the vector command to the system of the electronic apparatus 100, so that the electronic apparatus 100 executes the return key function to exit an executing program of the electronic apparatus 100 or to return to the last page. When the motion vector MV2 is generated, the operation unit 20 obtains the vector command of the motion vector MV2, so that the electronic apparatus 100 executes the function key function to allow the executing program of the electronic apparatus 100 to show available menus. When the motion vector MV3 is generated, because the motion vector MV3 is an unlock gesture preset by the user, the operation unit 20 sends the vector command of the motion vector MV3 to the system of the electronic apparatus 100 to allow the executing program of the electronic apparatus 100 to be unlocked.

In another embodiment, when the electronic apparatus 100 is in a locked mode, the operation unit 20 executes a first unlock determine procedure according to the motion vector signal MVS. The motion vector signal MVS may comprise one or multiple vectors. The operation unit 20 executes a second unlock determine procedure according to the fingerprint images FIM. When both the first unlock determine procedure and the second unlock procedure are passed, the operation unit 20 allows the electronic apparatus 100 to exit the locked mode. In other words, when both the fingerprint recognition and the gesture recognition are passed, the electronic apparatus 100 can exit the locked mode. In one embodiment, the priority and the necessity of the first unlock determine procedure and the second unlock determine procedure for exiting the locked mode are determined by an application program having registered fingerprint information. It is noticed that, the locked mode may be a sleep locked mode of the electronic apparatus or may be a file access locked mode for accessing certain files in the electronic apparatus. In other words, in the sleep locked mode, the user slides the screen of the electronic apparatus to unlock the electronic apparatus and allows the electronic apparatus to enter into a power on mode or a normal mode; conversely, in the file access locked mode, the user unlocks the electronic apparatus to obtain the access authority of the file in the electronic apparatus 100. Alternatively, the locked mode may be any mode which requests for the fingerprint recognition results for user checking.

In practice, when the electronic apparatus 100 is in an unlocked mode, the operation unit 20 generates the motion vector signal MVS according to the fingerprint images FIM received within a predetermined time. Alternatively, when the electronic apparatus 100 enters into the vector mode of an unlocked mode, the operation unit 20 allows the electronic apparatus 100 to execute a specific function according to the motion vector signal MVS. In a further option, when the electronic apparatus 100 is in a non homepage and unlocked mode, the operation unit 20 executes a homepage key function according to a first fingerprint image of the fingerprint images FIM, so that the electronic apparatus 100 is switched back to a homepage mode.

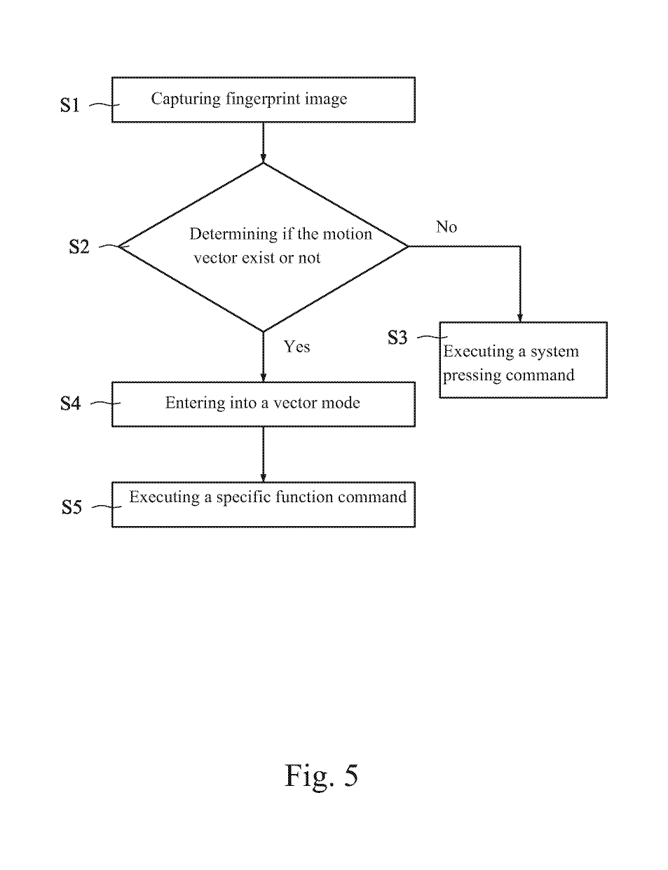

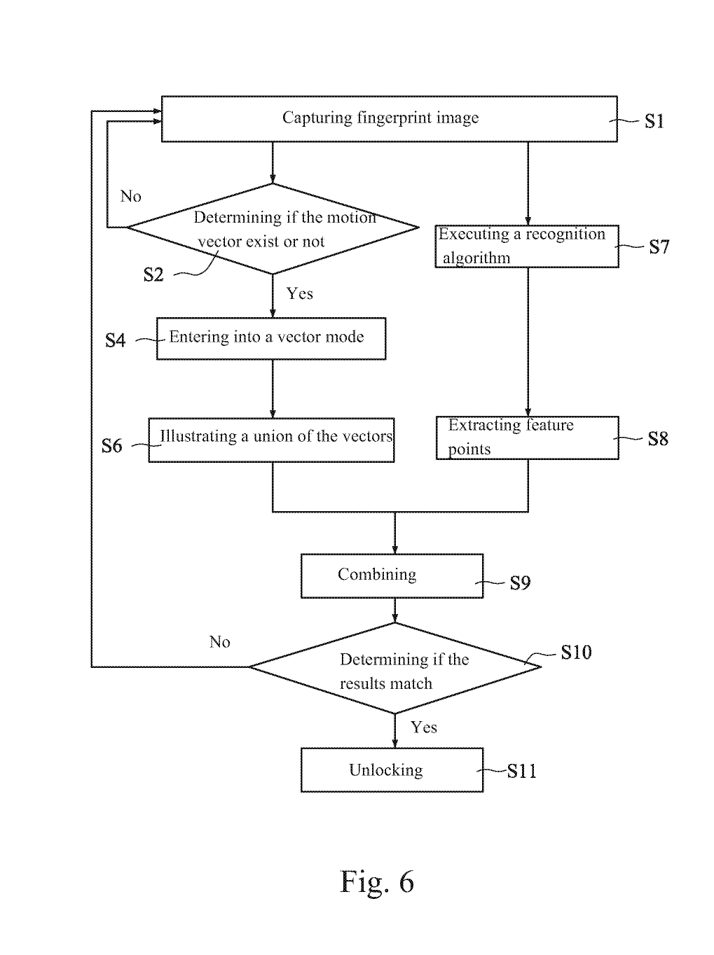

FIG. 5 illustrates a control procedure flowchart of the electronic apparatus in an unlocked mode of one embodiment of the instant disclosure. As shown in FIG. 5, the control procedure of the electronic apparatus in the unlocked mode comprises following steps. In the step S1, capturing a fingerprint image. In the step S2, determining if the motion vector is generated, if no, entering into the step S3, i.e., executing a system pressing command, for example, a home command; if yes, entering into the step S4 and then executing the specific function command. FIG. 6 illustrates a control procedure flowchart of the electronic apparatus in a locked mode of one embodiment of the instant disclosure. As shown in FIG. 6, the steps S1, S2, and S4 are the same as those shown in FIG. 5. After the step S4, the step S6 is executed, i.e., illustrating a union of the vectors. On the other hand, after the step S1, the step S7 is executed, i.e., executing a recognition algorithm And then, after the step S7, the step S8 is executed, i.e., extracting feature points of the fingerprint images. Next, in the step S9, the results of the steps S6 and S8 are combined. Next, the step S10 is executed, i.e., determining if the motion vector and the feature points are met with the preset motion vector and the preset feature points, if no, back to the step S1; if yes, executing the unlock step (the step S11).

In other words, the operation unit is provided for recognizing the fingerprint image or for comparing the fingerprint feature points. The operation unit may be the central processing unit (CPU) of the mobile phone or an external computation processor. The fingerprint sensor captures fingerprint images at different time instants. The vector of each of the fingerprint images is determined according to an image determination algorithm. Then, the moving direction of the finger is determined according to the result of the vector determination. Next, the result of the moving direction of the finger is provided to replace the return key command and the function key command which are originally executed by the touch control function of the mobile phone. For example, if the operation unit obtains a leftward vector result, the vector result is provided as a return key command and the return key function is executed accordingly; if the operation unit obtains a rightward vector result, the vector result is provided as a function key command and the function key function is executed accordingly. Such vector action mode may be in any vector format depended on the setting of the device manufacturer or the setting of the user. However, it is noticed that, the vector representing the return key function should be opposite with or have obvious differences from and the vector representing the function key function, so that the operation unit can recognize the vectors easily and the user can perform the vectors conveniently.

In another embodiment, the finger may move continuously on the fingerprint sensor, and the operation unit compares the images obtained at different time instants from each other to obtain a continuous vector unit by the image recognition algorithm. The result of the vector unit may form any text, number, or graph illustrated by the user. The text, number, or graph may be combined with the fingerprint image obtained by the fingerprint sensor or combined with the feature points computed by the fingerprint computation procedure. The combination is then further computed by algorithms to form a much safer and secret biometric lock. The biometric lock may comprise: (a) the text, number, or graph formed by the fingerprint image vector; (b) the fingerprint image or the feature points computed by the fingerprint computation procedure; and (c) the order of the data showing in item (a) and item (b).

When the mobile device is encrypted, unlocked, or performs actions request the fingerprint recognition command, the fingerprint image is sent to the image temporal storing region after the fingerprint image is read by the fingerprint sensor. If the image temporal storing region only obtains a preset number of images in a preset time, meaning that the user is performing fingerprint recognition. Conversely, if the image temporal storing region obtains images having a greater number than the preset number in a preset time or if the displacement of the vector changes obviously, the image comparison unit performs the speed determination, and then the motion vector processing unit performs the motion vector determination to obtain a motion vector output. Accordingly, the system of the mobile phone can obtain information which can form numbers, texts, or gesture commands.

In fingerprint registration software, the user can set if an intersection determination of numbers, texts, or gestures is added, and the finger of the user is pressed on or moved on the fingerprint sensor to complete the registration of the fingerprint or to complete the setting of numbers, texts, or gestures. When the user has to apply the encryption or the unlocking function, or when the fingerprint determination mechanism applied by the user needs to be checked, the finger of the user needs to illustrate images of the preset number, text, or gesture on the fingerprint sensor before or after the finger of the user presses on or slides over the fingerprint sensor to obtain the fingerprint information. Therefore, the images illustrated by the user can be combined with the fingerprint information of the user for the software to execute the intersection determination.

In the case of the mobile phone is in a non homepage, the display returns to the homepage when the fingerprint sensor is pressed. Upon the mobile phone executing an application program, when a user tends to return to the last page or to manipulate the mobile phone, the finger of the user slides over the fingerprint sensor, and then the system determines the action of the user satisfies the direction of the motion vector of the return key, so that the display performs responds the user's request. Conversely, when the user tends to use the function key, the finger of the user slides over the fingerprint sensor, so that the system determines the action of the user meets the direction of the motion vector of the function key.

According to the electronic apparatus of embodiments of the instant disclosure, the key configuration of the electronic apparatus can be simplified. In addition, the fingerprint sensor can be adapted to achieve the fingerprint recognition function, the homepage key function, the return key function, and the gesture determination function. Moreover, the security of the electronic apparatus can be improved by the combination of the gesture determination function and the fingerprint recognition function.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An electronic apparatus comprising:
a fingerprint sensor provided for sensing a plurality of fingerprint images of a finger at different time instants; and
an operation unit determining one or multiple moving directions of the finger according to the fingerprint images in a vector mode to generate a motion vector signal;
wherein, the electronic apparatus executes a specific function according to the motion vector signal, and the specific function is selected from a group consisting of a return key function, a function key function, and an unlocking function, and wherein when the electronic apparatus is in a locked mode, the operation unit executes a first unlock determine procedure according to the motion vector signal, the motion vector signal comprises one or multiple vectors, and the operation unit executes a second unlock determine procedure according to the fingerprint images, and wherein the operation unit allows the electronic apparatus to exit the locked mode when both the first unlock determine procedure and the second unlock determine procedure are passed.

2. The electronic apparatus according to claim 1, wherein when the electronic apparatus is in an unlocked mode, the operation unit generates the motion vector signal according to the fingerprint images received within a predetermined time.

3. The electronic apparatus according to claim 1, wherein when the electronic apparatus enters into the vector mode of an unlocked mode, the operation unit allows the electronic apparatus to execute the specific function according to the motion vector signal.

4. The electronic apparatus according to claim 1, wherein when the electronic apparatus is in the locked mode, the priority and the necessity of the first unlock determine procedure and the second unlock determine procedure for exiting the locked mode are determined by an application program having registered fingerprint information.

5. The electronic apparatus according to claim 1, wherein when the electronic apparatus is in a non homepage and unlocked mode, the operation unit executes a homepage key function according to a first fingerprint image of the fingerprint images, so that the electronic apparatus is switched back to a homepage mode.

6. The electronic apparatus according to claim 1, wherein the return key function allows the electronic apparatus to exit an executing program thereof or to return to the previous page, the function key function allows the executing program of the electronic apparatus to show available menus, and the unlocking function allows the executing program of the electronic apparatus to be unlocked.

7. The electronic apparatus according to claim 1, further comprising:
a storage electrically connected to the operation unit, wherein in a login mode, the operation unit processes one or more of the fingerprint images as fingerprint feature data and stores the fingerprint feature data in the storage for subsequent comparisons.

8. An electronic apparatus comprising:
a fingerprint sensor provided for sensing a plurality of fingerprint images of a finger at different time instants; and
an operation unit determining one or multiple moving directions of the finger according to the fingerprint images in a vector mode to generate a motion vector signal;
wherein, the electronic apparatus executes a specific function according to the motion vector signal, and the specific function is selected from a group consisting of a return key function, a function key function, and an unlocking function, and wherein the motion vector signal represents a text or a number.

9. The electronic apparatus according to claim 8, wherein when the electronic apparatus enters into the vector mode of an unlocked mode, the operation unit allows the electronic apparatus to execute the specific function according to the motion vector signal.

10. The electronic apparatus according to claim 8, wherein when the electronic apparatus is in a locked mode, the priority and the necessity of a first unlock determine procedure and a second unlock determine procedure for exiting the locked mode are determined by an application program having registered fingerprint information.

11. The electronic apparatus according to claim 8, wherein when the electronic apparatus is in a non homepage and unlocked mode, the operation unit executes a homepage key function according to a first fingerprint image of the fingerprint images, so that the electronic apparatus is switched back to a homepage mode.

12. The electronic apparatus according to claim 8, wherein the return key function allows the electronic apparatus to exit an executing program thereof or to return to the previous page, the function key function allows the executing program of the electronic apparatus to show available menus, and the unlocking function allows the executing program of the electronic apparatus to be unlocked.

13. The electronic apparatus according to claim 8, further comprising:
a storage electrically connected to the operation unit, wherein in a login mode, the operation unit processes one or more of the fingerprint images as fingerprint feature data and stores the fingerprint feature data in the storage for subsequent comparisons.

14. An electronic apparatus comprising:
a fingerprint sensor provided for sensing a plurality of fingerprint images of a finger at different time instants; and
an operation unit determining one or multiple moving directions of the finger according to the fingerprint images in a vector mode to generate a motion vector signal;
wherein, the electronic apparatus executes a specific function according to the motion vector signal, and the specific function is selected from a group consisting of a return key function, a function key function, and an unlocking function, and wherein when the electronic apparatus is in a locked mode, the priority and the necessity of a first unlock determine procedure and a second unlock determine procedure for exiting the locked mode are determined by an application program having registered fingerprint information.

15. The electronic apparatus according to claim 14, wherein when the electronic apparatus is in an unlocked mode, the operation unit generates the motion vector signal according to the fingerprint images received within a predetermined time.

16. The electronic apparatus according to claim 14, wherein when the electronic apparatus enters into the vector mode of an unlocked mode, the operation unit allows the electronic apparatus to execute the specific function according to the motion vector signal.

17. The electronic apparatus according to claim 14, wherein when the electronic apparatus is in a non homepage and unlocked mode, the operation unit executes a homepage key function according to a first fingerprint image of the fingerprint images, so that the electronic apparatus is switched back to a homepage mode.

18. The electronic apparatus according to claim 14, wherein the return key function allows the electronic apparatus to exit an executing program thereof or to return to the previous page, the function key function allows the executing program of the electronic apparatus to show available menus, and the unlocking function allows the executing program of the electronic apparatus to be unlocked.

19. The electronic apparatus according to claim 14, further comprising:
a storage electrically connected to the operation unit, wherein in a login mode, the operation unit processes one or more of the fingerprint images as fingerprint feature data and stores the fingerprint feature data in the storage for subsequent comparisons.

20. The electronic apparatus according to claim 14, wherein the motion vector signal represents a text or a number, and wherein when the electronic apparatus is in a locked mode, the operation unit executes the first unlock determine procedure according to the motion vector signal, the motion vector signal comprises one or multiple vectors, and the operation unit executes the second unlock determine procedure according to the fingerprint images, and wherein the operation unit allows the electronic apparatus to exit the locked mode when both the first unlock determine procedure and the second unlock determine procedure are passed.
